(19) United States
(12) Patent Application Publication
(10) Pub. No.: US 2014/0198824 A1
(43) Pub. Date: Jul. 17, 2014

(54) Sensor, System Having A Sensor and A Measurement Object, and Method For Temperature Measurement By Means of A Sensor

(71) Applicants: Josef Nagl, Künzing (DE); Reinhold Hoenicka, Ortenburg (DE); Felix Mednikov, Ortenburg (DE); Werner Groemmer, Ortenburg (DE)

(72) Inventors: Josef Nagl, Künzing (DE); Reinhold Hoenicka, Ortenburg (DE); Felix Mednikov, Ortenburg (DE); Werner Groemmer, Ortenburg (DE)

(73) Assignee: MICRO-EPSILON MESSTECHNIK GMBH & CO. KG, Ortenburg (DE)

(21) Appl. No.: 14/116,568

(22) PCT Filed: Mar. 16, 2012
(86) PCT No.: PCT/DE2012/200016

§ 371 Date: Nov. 8, 2013

(30) Foreign Application Priority Data
May 11, 2011 (DE) 102011101224.2
Aug. 19, 2011 (DE) 102011110666.2

(51) Int. Cl. G01K 1/20

(52) U.S. Cl. CPC G01K 1/20
USPC 374/163

(57) ABSTRACT

An eddy current sensor that works in contact-free manner, for temperature measurement on an electrically conductive measurement object or component, wherein the measurement is independent of the distance between the sensor and the measurement object/component, characterized by determination of the inherent temperature of the sensor, preferably at the location of the measurement coil of the sensor, wherein the influence of the inherent temperature of the sensor or of a temperature gradient at the sensor on the result of the temperature measurement on the measurement object or component is compensated. A system comprises a corresponding sensor and an electrically conductive measurement object. A method serves for temperature measurement on a measurement object or component, by means of a corresponding sensor.

The invention relates to an eddy current sensor that works in contact-free manner, for temperature measurement on an electrically conductive measurement object or component, wherein the measurement is independent of the distance between the sensor and the measurement object/component.

Furthermore, the invention relates to a system comprised of an eddy current sensor that works in contact-free manner and an electrically conductive measurement object that can be assigned to any desired component, for temperature measurement on the component, wherein the measurement is independent of the distance between the sensor and the measurement object or component, particularly with use of the sensor according to the invention.

Furthermore, the invention relates to a method for temperature measurement on a measurement object or component, by means of an eddy current sensor that works in contact-free manner, wherein the measurement is carried out independent of the distance between the sensor and the measurement object/component, particularly with use of a corresponding sensor.

Temperature measurement by means of an eddy current method is sufficiently known from practice. Frequency, this contact-free method is used if the measurement object is moving, whether this is because it is a rotating object such as the rotor or the shaft of a drive or a motor, for example, a rotating brake disk or an object that is moving past the sensor, such as, for example, a web of sheet metal in a rolling process. Contact-free measurement can also be required in the case of objects that are difficult to access, because in this way, a measurement can be taken from a greater distance from the object. Furthermore, contact-free measurement is practical in particularly difficult ambient conditions, such as, for example, at high temperatures, or if the object is exposed to shocks and/or vibrations.

Temperature measurement by means of eddy current has been known for a long time. However, because the eddy current effect is dependent on distance, either the distance of the sensor from the measurement object must be kept constant, or the change in distance must be compensated.

From DE 24 10 067 A, a coil system composed of a long primary coil and two short secondary coils in a differential circuit is known. An evaluation of the phase angle between exciter signal and output signal is provided. The sensor is moved until the maximal phase angle has been reached. The measurement is independent of distance. Disadvantages of the known coil systems lie in the large construction in the axial direction, and in complicated adjustments to achieve independence from distance.

From DE 27 11 797 A1, a difference amplifier having a measurement coil, a dummy coil, an oscillator, a phase shifter, and a synchronous reception circuit is known. By means of adjusting the amplification factor and the phasing at the reception circuit, it is possible to undertake a distance-dependent temperature measurement.

From EP 0 423 084 B1, the structure of an impedance bridge having a measurement coil and a compensation coil is known. A measurement of the amount and phase of the bridge voltage takes place, as does a determination of calibration curves with reference to the temperature of the measurement object and the distance from the measurement object. The determination of the measurement object temperature takes place by means of a comparison of the measurement with the calibration curves. Compensation of the sensor temperature takes place using a compensation coil, taking into consideration the distance, by means of calibration curves. It is disadvantageous that the determination of the object temperature is undertaken by means of a comparison with calibration curves. Temperature gradients at the sensor are not detected. Furthermore, compensation of the sensor temperature is possibly at only one work point.

The present invention is therefore based on the task of configuring and further developing an eddy current sensor that acts in contact-free manner, of the type-defining kind, in such a manner that a temperature measurement on an electrically conductive measurement object or a component provided with a corresponding measurement object, which measurement is not influenced by external influences, to the greatest possible extent, is possible. The sensor is supposed to have the simplest possible structure. A corresponding system having a sensor and a measurement object is to be indicated. The same holds true for a corresponding method, namely for use of such a sensor.

The above task is accomplished by means of the characteristics of the independent claims 1, 15, and 16.

Accordingly, the eddy current sensor that works in contact-free manner is characterized by determination of the inherent temperature of the sensor, preferably at the location of the measurement coil of the sensor, where the influence of the inherent temperature of the sensor or of a temperature gradient at the sensor on the result of the temperature measurement at the measurement object or component is compensated.

With regard to the system according to the invention, the above task is accomplished by means of the characteristics of claim 15, namely in that the inherent temperature of the sensor is measured, and its influence on the result of the temperature measurement is compensated.

The method according to the invention accomplishes the above task by means of the characteristics of the further independent claim 16, namely also in that the inherent temperature of the sensor is measured, and its influence on the result of the temperature measurement is compensated.

According to the invention, the following deliberation/recognition is the basis here:

During temperature measurement, the desired measurement value is the temperature of the measurement object. However, because the sensor itself is also exposed to a temperature influence, which could distort the measurement result, it is necessary to determine the temperature measurement independent of the sensor temperature itself. This has not been taken into consideration until now in the state of the art, or only taken into consideration in one work point.

With regard to the measurement method, fundamentally the following should be explained first:

Sensors for contact-free determination of the temperature of a measurement object work, for example, according to the eddy current principle. In this connection, a coil is supplied with alternating current or voltage. The coil is situated in the region of influence of an electrically conductive measurement object, the temperature of which is to be determined. Eddy currents are induced in the measurement object by means of the electromagnetic alternating field. These currents are independent of the frequency of the alternating field, of the distance between coil and measurement object, and of the conductivity and permeability of the measurement object.

Proceeding from Faraday's law of induction

$$rot \vec{E} ( t ) = - \frac{\partial }{\partial t} \vec{B} ( t )$$

a magnetic field that can be changed over time generates eddy currents \vec{j}(t) in a conductor according to Ohm's law

\vec{j}(t)=θ·\vec{E}(t)

and with the magnetic induction

\vec{B}(t)=μ·\vec{H}(t)

in the conductor, which currents follow the relationship

$$rot \vec{j} ( t ) = - σ \cdot μ \cdot \frac{\partial }{\partial t} \vec{H} ( t ) . \qquad ( Equation 1 )$$

The eddy currents generate an electromagnetic field that reacts on the exciter coil and influences the impedance of the latter.

The specific resistance of a metallic conductor is temperature-dependent, according to the known formula

r(T)=r₀·(1+α(T−T₀)+β·(T−T₀)²) (Equation 2)

with the linear temperature coefficient α and the square temperature coefficient β.

After a simple reformulation for conductivity

$$σ ( T ) = \frac{1}{r ( T )}$$

the following expression for the temperature dependence of conductivity is obtained:

$${σ}_{T} = \frac{{σ}_{0}}{1 + α \cdot ( T - {T}_{0} ) + β \cdot {( T - {T}_{0} )}^{2}} \qquad ( Equation 3 )$$

### Where

θ_{T}=conductivity at the temperature T
θ₀=conductivity at the temperature T₀
α=linear temperature coefficient
β=square temperature coefficient

If one solves Equation 3 according to the temperature, one obtains:

$$T = \frac{- α + \sqrt{{α}^{2} - 4 β * ( 1 - \frac{{σ}_{0}}{{σ}_{t}} )}}{2 * β} + {T}_{0} \qquad ( Equation 4 )$$

a relationship between the temperature T and the conductivity θ.

Frequently, it is sufficient to merely consider the linear temperature coefficient, then Equation 3 is simplified to

$${σ}_{T} = \frac{{σ}_{0}}{1 + α * ( T - {T}_{0} )} , \qquad ( Equation 5 )$$

from which it follows, for the temperature T:

$$T = \frac{1}{α} * ( \frac{{σ}_{0}}{{σ}_{T}} - 1 ) + {T}_{0} \qquad ( Equation 6 )$$

At higher temperatures from approx. 80° C. or with higher precision requirements, linear approximation is no longer sufficient; then, the square temperature must be included in the calculation, i.e. Equation 4 must be used.

The determination of the conductivity θ takes place by means of an impedance measurement of the coil. The (complex) impedance Z of the coil is dependent, according to Equation 1, in the case of the presence of a measurement object at the distance d from the coil, also on the material parameters θ and μ of the measurement object. The impedance is therefore a function of the variables

Z=Z(θ_{T}, μ, d, r, T_{S}, ω, . . . )

where
θ_{T}=conductivity at the temperature T
d=distance of the coil from the measurement object
T_{S}=inherent temperature of the coil
μ=permeability of the measurement object
ω=frequency of the alternating field
r=average radius of the coil.

The impedance is therefore a function of the material parameters (θ, μ) and parameters of the coil (for example average radius r, inherent temperature T_{S}) or of the exciter frequency (ω) as well as its distance d from the measurement object. By means of suitable mathematical methods, this function can be further simplified or calculated using numerical methods, to the effect that the material parameters can be determined. Therefore a determination of the conductivity and thereby of the temperature of the measurement object is possible by means of an impedance measurement of the coil.

For example, the impedance of the coil can be divided up, using a mathematical model, into a component Z₀ and a component Z_{C}, where Z₀ depends only on the coil, without the influence of the measurement object, and Z_{C} represents the coupling impedance between coil and measurement object:

Z=Z₀+Z_{C}

For the case of non-ferromagnetic measurement objects, i.e. μ=μ₀, one obtains a measurement regulation for conductivity that is independent of distance:

$${σ}_{T} = \frac{9 * {tan}^{2} {ϕ}_{c}}{2 * {μ}_{0} * ω * {r}^{2}} \\ Where \\ \begin{matrix}tan {ϕ}_{C} = \frac{Im \{ {Z}_{C} \}}{Re \{ {Z}_{C} \}} & \begin{matrix}the phase angle between real part and \\ imaginary part of the coupling impedance {Z}_{C} .\end{matrix} \\ ω = & the frequency of the alternating field \\ r = & the average radius of the coil\end{matrix} \qquad ( Equation 7 )$$

If one inserts Equation 7 into Equation 6, one obtains, for the temperature:

$$T = \frac{1}{α} \cdot ( \frac{{σ}_{0}}{k \cdot {tan}^{2} ϕ} \cdot ω \cdot {r}^{2} - 1 ) + {T}_{0} \qquad ( Equation 8 )$$

where

$$k = \frac{9}{2 * {μ}_{0}}$$

In analogous manner, Equation 7 can also be inserted into Equation 4, which yields an expression for the temperature T that is also dependent on the square temperature coefficient:

$$T = \sqrt{\frac{1}{β} \cdot ( \frac{{σ}_{0}}{k \cdot {tan}^{2} ϕ} \cdot ω \cdot {r}^{2} - 1 ) + {κ}^{2}} - κ + {T}_{0} \qquad ( Equation 9 )$$

with

$$κ = \frac{α}{2 β}$$

For the determination of the temperature, only a measurement of tan φ_{C} is required with this model, namely measuring the real and imaginary part of the impedance of the coil.

Fundamentally, all conductive objects can be used as a measurement object. Ideally, these possess a linear relationship according to Equation 5 between conductivity and temperature in the temperature range to be detected. In order to obtain a linear relationship between temperature and conductivity in the broadest possible range, which relationship is particularly necessary in the case of great temperature changes, particularly suitable materials could be used for the measurement object. Likewise, it is necessary for measurements in a large temperature range that a great relative change in the conductivity over the temperature is achieved. Metals such as titanium, tungsten or molybdenum, which demonstrate a great relative change in conductivity with the temperature, could be used for measurement objects. But other metals with suitable properties are also possible for achieving optimal results for the use in each instance.

The impedance of the coil can be measured using known methods. It can be measured, for example, by means of an evaluation of the real and imaginary part (or amount and phase) of a measurement coil supplied with alternating current, at a fixed frequency. From this, it is possible to draw a conclusion concerning the material parameters of the measurement object. Because the relationship between the conductivity and the temperature of the measurement object is known, a conclusion concerning the temperature of the measurement object can particularly be drawn with the electrical conductivity. In order to reduce the number of the temperature-dependent parameters of the measurement object, in a preferred embodiment of the sensor the material of the measurement object is selected in such a manner that the permeability is constant over the temperature progression (e.g. non-ferromagnetic metals, CFCs, semiconductor materials, liquids, . . . ). With suitable algorithms, this measurement is independent of the distance in defined ranges. This distance independence is particularly important in the case of large temperature ranges to be measured and in the case of rotating objects, because frequently, a variation in the distance between measurement object and sensor comes about due to temperature expansion of the materials or as the result of imbalance of the rotating objects.

If the permeability of the measurement object is not constant over the temperature, or in order to increase precision, the determination of the material parameters can take place at multiple frequencies. In this way, the informational content of the measurement can be expanded, in that the impedance of the coil is determined at two or more frequencies. In this way, clearly determined or actually over-determined equation systems for multiple material parameters are obtained, for example conductivity and permeability as a function of the temperature and of the distance.

In an alternative embodiment, the impedance of the coil could be measured in that it is operated, together with a capacitor, as a free-running oscillator. In this connection, the frequency and the amplitude of the oscillation can be used for evaluation of the material parameters. In the case of the LC oscillator, the basic frequency of the oscillator could be changed by switching the capacitance. In this way, the information content of the measurement can be increased, which can be used for suppression of additional interference influences.

The penetration depth of the electromagnetic alternating field in the measurement object is dependent on the frequency and the conductivity or permeability of the measurement object. Therefore, the depth of the eddy current effect can be influenced by means of adaptation of the frequency, at a given conductivity and permeability. Therefore the temperature can be determined only in a surface layer at high frequencies, while the temperature can be determined over a greater depth, as an integral value, at low frequencies.

Distance independence can be implemented as follows:

Because the impedance of the measurement coil is also dependent on the distance from the measurement object, it is necessary to take the influence of the distance into consideration. Instead of great effort and expenditure for a distance-stable holder, it is simpler and more cost-advantageous to measure and compensate the distance. This can also be done by means of measurement values of the impedance measurement, namely by means of
separate detection of real and imaginary part or amount and phase;
measurement of real and imaginary part or amount and phase at different frequencies, to increase the information content;
free-running oscillator; measurement of frequency and amplitude; switching of the vibration circuit capacitor for further resonance frequencies.

Alternatively, the distance can also be compensated by way of a multi-coil arrangement (that can be switched alternately) or differential coil arrangement, in known manner.

Inherent temperature independence can be achieved as follows:

The distance between measurement object and sensor is relatively slight, and therefore sufficient shielding of the heat radiation of the measurement object is not possible. Therefore, heating of the sensor by the measurement object can take place not only by means of radiation heat but also by means of convection heat. Heating of the sensor brings about a measurement error, by means of a change in the coil parameters. Thus, a change in temperature changes the impedance of the coil by means of the related change in resistance of the coil wire, thereby influencing the temperature measurement at the measurement object. Furthermore, the change in temperature can influence the measurement value on the basis of the thermal length expansion of the materials used. For example, the distance of the sensor from the measurement object can change as a result of the length expansion. Furtheiinore, the measurement can be influenced as a result of the length expansion of the sensor itself. Particularly in the case of larger sensors or particularly high-resolution measurements, temperature gradients that occur because of a temperature differential between the heated face side of the sensor and the cooler back side (or vice versa) can distort the measurement.

For this reason, it is necessary—in the manner according to the invention—for a precise, stable, and reproducible temperature measurement, to detect the inherent temperature of the sensor, and to compensate its influence on the temperature measurement.

For compensation of the inherent temperature of the sensor or temperature gradient, it is necessary to measure the temperature at the location of the coil. For this purpose, there are the following possibilities:
DC superimposition for a determination of the direct current resistance of the measurement coil. A direct current can be superimposed on the alternating current of the measurement coil. A conclusion concerning the ohmic resistance of the coil can be drawn from the change in the steady component, where the change in the resistance is a measure of the temperature change of the coil.
Temperature probes (NTC, PTC, PT100, . . . ). For temperature measurement of the sensor, a separate temperature probe can be embedded into the sensor, thereby making it possible to detect the temperature in the region of the measurement coil directly.
Temperature measurement winding (locally distributed for T-gradient compensation). A temperature measurement winding, which is disposed locally distributed about the measurement coil, additionally allows detection of the temperature gradient beyond the measurement coil. In order not to have any influence on the temperature measurement winding by the measurement object, on the one hand, and no influence on the measurement winding of the sensor by the temperature measurement winding, on the other hand, a bifilar arrangement of the temperature measurement winding is a preferred embodiment. This arrangement is particularly advantageous in the case of a construction of the sensor in a ceramic substrate.
Toroid winding (operated with alternating voltage). In order to eliminate the influence of the measurement object on the temperature measurement, a winding disposed around the measurement coil in toroid manner is practical. The parameters of this coil are influenced, to a great extent, only by the temperature of the measurement coil, because the field of a toroid coil forms only in the interior of the coil. In this connection, it is advantageous that a differential arrangement (for example in the form of a half bridge supplied with direct voltage) is to be constructed in connection with the measurement coil. In this connection, the toroid coil brings about direct compensation of the sensor temperature.

Differential coil arrangement. Likewise, such a differential coil arrangement is possible with a further compensation coil, similar in structure to the measurement coil. In this connection, the compensation coil is damped in defined manner by a reference object, and remains uninfluenced by the temperature-affected measurement object. Temperature compensation of the sensor is possible by means of a fixed distance of the reference measurement object, for example in a half bridge circuit.

The sensor can be structured analogous to the known eddy current distances sensors, in that a wound coil is disposed in a housing, on the face side, toward the measurement object. The coil is connected with the electronics by way of a sensor line. The electronics supply the coil with alternating current at a constant frequency. The impedance of the coil is evaluated in the electronics, in that the real part and the imaginary part of the impedance are evaluated with a microcontroller or signal processor. Then, the distance and the temperature, for example, can be determined from the two measurement values.

For high-temperature applications, the sensor can be produced from a ceramic, for example, in that a coil is embedded in ceramic. Production of the coil in multi-layer ceramic substrates (LTCC or HTCC) is particularly advantageous. In this way, the coil is embedded in a manner protected from ambient influences. A further advantage of the ceramic is its low thermal expansion coefficient, so that a relatively stable measurement value is possible. The additional coil for temperature compensation can also be included in the multi-layer ceramic technique, in very simple and cost-advantageous manner. The sensor element could be part of the housing of the sensor, for example in that it is firmly connected with the metal housing by means of active soldering. However, other connection technologies such as gluing, pressing, soft soldering, etc., are also possible.

The sensor according to the invention can be used as follows:

The sensor according to the invention can be used, for example, for temperature measurement of brakes. Brakes reach extremely high temperatures during braking, in the range of several hundred to thousand degrees Celsius. The temperatures to be measured therefore extend over a very broad range. The stress on the sensor due to the temperature introduction by way of radiation and/or convection is therefore very high. For this reason, the sensor is composed of a coil that is embedded in multi-layer ceramic and sits in a metal housing. The sensor can measure the temperature of the brake disk directly, for example in that it is affixed on the brake caliper. The distance of the sensor from the brake disk can change because of the great mechanical stresses. This change in distance is detected and compensated by the evaluation electronics. Because the brake disk reaches very high temperatures during the braking process (up to glowing red-hot), the sensor is greatly heated by the radiation. So that this heating does not have any influence on the measurement result, the change in temperature of the sensor must be compensated. For this purpose, direct current is applied to the coil, for example. Because of the change in temperature of the coil, its direct current resistance also changes. This change can be determined or measured, and thereby the change in temperature of the sensor can be compensated.

Instead of measuring directly on the brake disk, an indirect measurement, for example at the brake caliper or at another suitable location of the brake, is also possible. A particularly suitable material can be brought into thermal contact with the brake or its holder, the temperature of which material is determined in the manner according to the invention.

Such measurements can be conducted in all possible brakes, for example on motor vehicles, trucks, or on rail vehicles or aircraft. Using the temperature measurement, the status of the brake can be monitored, in order to avoid premature wear. Also, measures for cooling can be initiated in timely manner, in order to prevent damage to the brake. It is also advantageous that shut-down times are avoided while the brake status is monitored in the manner according to the invention.

Further examples of application can be:
Contact-free temperature measurement in a rolling mill, where metal sheets are monitored during rolling.
Monitoring of machines and systems, particularly rotating or moving machine parts, etc.

The method for determining the temperature T of a work piece, where the work piece is electrically conductive, which method belongs to the invention, will be described as an example. According to the method, an electromagnetic alternating field is generated in the immediate vicinity of a work piece, using a coil, in such a manner that the field generates eddy currents at the surface of the electrically conductive work piece. The eddy currents react on the field. The influence of the eddy currents on the alternating field is measured by means of the change in impedance of the coil.

A very particular method step, according to which the measurement is undertaken with setting of the frequency at a fixed value, is of very particular importance, where the coupling impedance

Ż=Z_{C}·e^{iφ}^{_{C}}

of the coil is determined at this frequency. On this basis, the temperature “T” of the work piece can be determined, specifically according to the equation:

$$T = \frac{1}{α} \cdot ( \frac{{σ}_{0}}{k \cdot {tan}^{2} ϕ} \cdot ω \cdot {r}^{2} - 1 ) + {T}_{0} ,$$

where

$$k = \frac{9}{2 * {μ}_{0}}$$

where
θ=electrical conductivity of the work piece (1) at 20° C.
α=the temperature coefficient of the electrical resistance of the work piece,
where

$$tan {ϕ}_{C} = \frac{{X}_{C}}{{R}_{C}} ,$$

X_{C}=imaginary part of the coupling impedance Z_{C};
R_{C}=real part of the coupling impedance Z_{C};

$$r = \frac{1}{2} ( {d}_{1} - {d}_{2} )$$

where
r=average radius of the coil (2)
d₁=outside diameter of the coil (2)
d₂=inside diameter of the coil (2)
ω=the circuit frequency of the alternating field
φ_{C}=the phase angle of the coupling impedance.

The method according to the invention is further developed, in advantageous manner, in that the calculation of the temperature takes place using a mathematical model that describes a coil used for generation of the alternating field, and a mathematical model that takes into consideration the structure of the work piece and its electromagnetic properties, in the previously mentioned mathematical model.

Furthermore, it is possible that the electrical conductivity a of the work piece and the distance “h” between the coil and the surface of the work piece are used in the stated calculation of the temperature of the work piece.

The coil used to generate the electromagnetic alternating field can also be used, simultaneously, as a receiver coil.

To determine the temperature of a work piece that is electrically conductive, a particular apparatus can be used, which includes elements for generating an electromagnetic alternating field in the immediate vicinity of the surface of the work piece. The field generates eddy currents in the work piece, which react on the field. Furthermore, means for measuring the change in impedance of the coil are provided, where the apparatus contains a special arrangement that serves for determining the coupling impedance Z_{K} of the coil and for calculations on the basis of the temperature of the work piece.

The elements for generating the alternating field comprise a coil that can be described by a mathematical model. The arrangement has a composition such that it is able to use the mathematical model during its calculation.

The coil can consist of a single layer of windings.

The arrangement preferably has a composition such that it is able to calculate the temperature “T” using the mathematical model for the coil and a mathematical model. In this connection, the electrical conductivity “θ” of the work piece and the distance “h” between the coil and the work piece are taken into consideration.

Furthermore, the apparatus can comprise at least one coil placed at a distance “h” from the work piece. Also, elements for measuring the complex impedance or the real and imaginary part of the coil at a specific frequency “ω” can be used.

The method for determining the temperature “T” of an electrically conductive work piece can furthermore comprise the following steps:

First of all, an eddy current sensor is made available, which has an electrical coil having a pre-selected diameter. The coil is positioned at a selected separation distance “h” from the work piece. An alternating current having a selected angular frequency is applied to the coil.

The following further steps are significant:
the complex impedance Ż=Z₀·e^{iφ}^{₀} of the coil (2) is measured, without the influence of the work piece (1);
from Zₒ, real part Re Zₒ and imaginary part Im Zₒ are determined;
the complex impedance Z_{S} of the coil (2) is measured at a basic distance hₒ from the work piece, the electrical conductivity “θ” of which is varied from θₘᵢₙ to θₘₐₓ;
Re Z_{S} and Im Z_{S} are determined;
the real part Re_{C} and the imaginary part Im_{C} of the coupling impedance Z_{C} are calculated, where

Re_{C}=ReŻ_{S}−Re_{C}Ż₀ (1)

Im_{C}=ImŻ_{S}−Im_{C}Ż₀ (2)
the tan φ_{C} of the coupling impedance Z_{C} is calculated, where

$$tan {ϕ}_{C} = \frac{{Im}_{C}}{{Re}_{C}} \qquad ( 3 )$$

the temperature “T” of the work piece (1) is calculated, where

$$T = \frac{1}{α} \cdot ( \frac{{σ}_{0}}{k \cdot {tan}^{2} ϕ} \cdot ω \cdot {r}^{2} - 1 ) + {T}_{0} \qquad ( 4 )$$

where

$$k = \frac{9}{2 * {μ}_{0}}$$

According to Equation 4, it becomes clear that at known values α, θₒ, ω, r, it is sufficient for the temperature determination of a work piece to measure exclusively tan φ_{C}, where “T” is essentially independent of the distance “h” between the coil (2) and the work piece (1).

There are now various possibilities for configuring and further developing the teaching of the present invention in advantageous manner. For this purpose, reference is made, on the one hand, to the claims dependent on claim 1, and, on the other hand, to the following explanation of preferred exemplary embodiments of the invention, on the basis of the drawing. In combination with the explanation of the preferred exemplary embodiments of the invention using the drawings, preferred embodiments and further developments of the invention are also explained in general. The drawing shows:

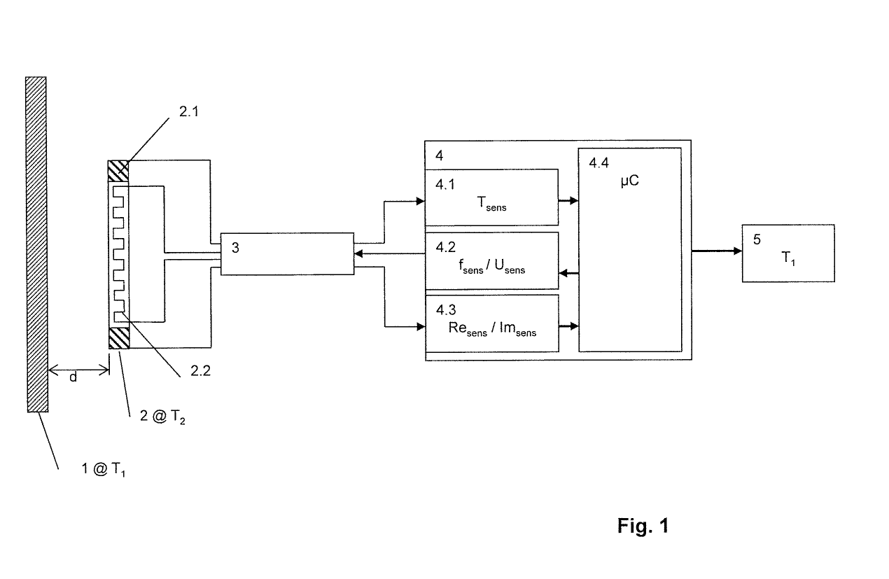

FIG. 1 in a block schematic, the fundamental structure and the fundamental circuitry of a sensor according to the invention, for use in the method according to the invention,

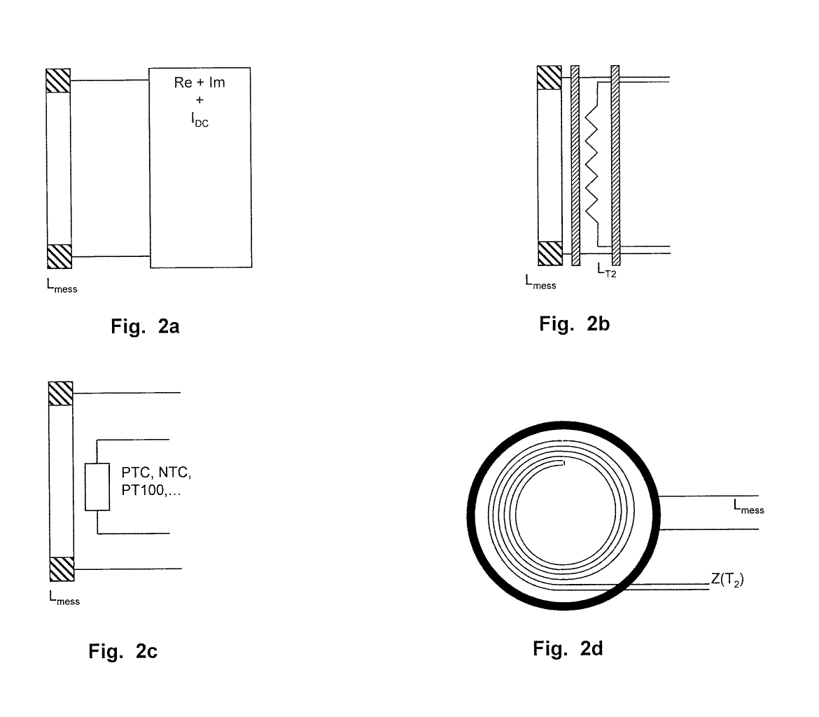

FIGS. 2a to 2d in a fundamental representation, various possibilities for determining the inherent temperature of the sensor,

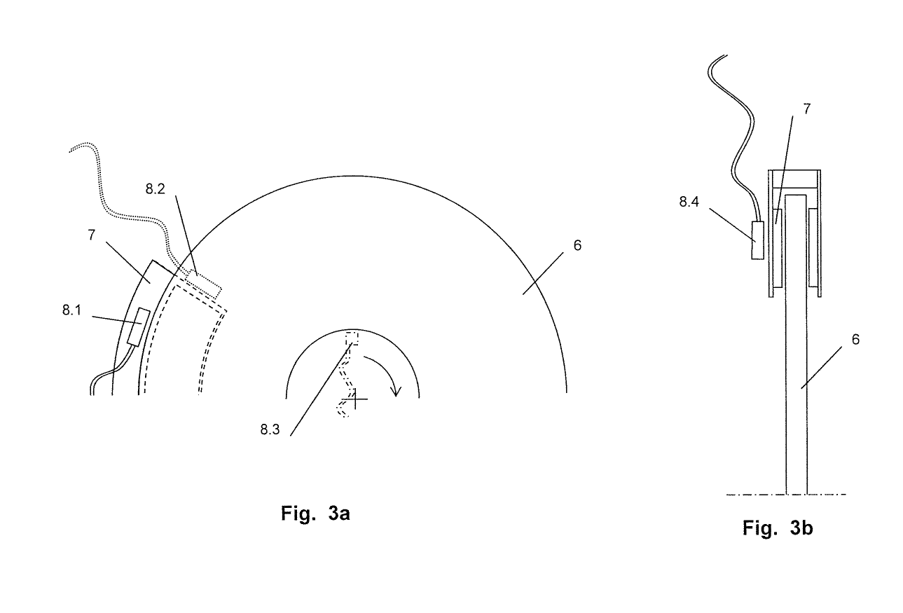

FIGS. 3a and 3b in a fundamental representation, possible applications of sensors according to the invention, using the example of measuring the temperature of a brake disk or of a brake lining of a brake, and

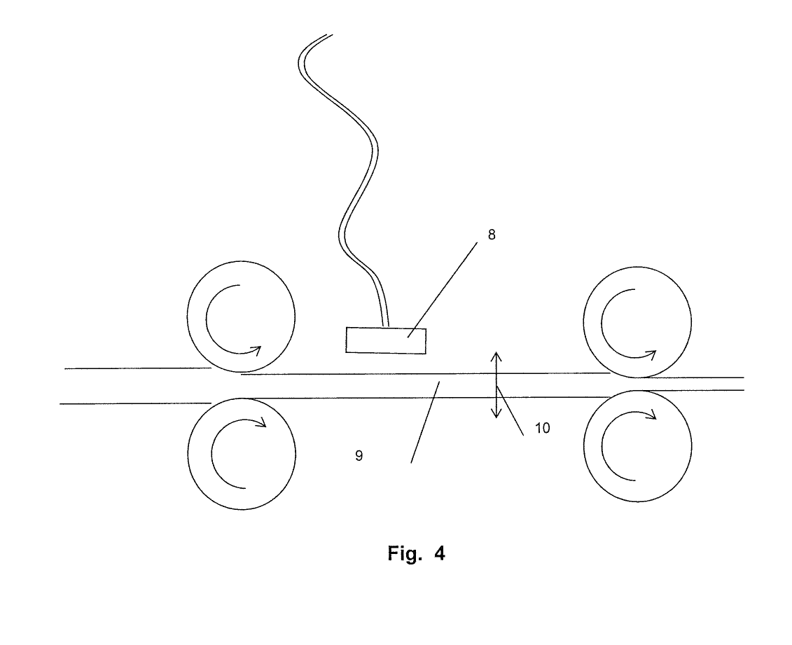

FIG. 4 in a schematic view, a further exemplary embodiment of use of the sensor according to the invention, using the example of measuring the temperature of non-ferromagnetic strips, for example in a rolling mill, during the rolling process.

According to FIG. 1, the measurement object 1 has the temperature T₁, whereas the measurement element has the temperature T₂. The measurement element 2 consists of the measurement coil 2.1 and the compensation element 2.2. The measurement element 2 is connected with the evaluation unit 4 by way of a feed line 3. The block 4.1 serves for a determination of the inherent temperature of the sensor. The turn-on block 4.2 generates the required signals for turning on the sensor at the frequency fₛₑₙₛ and the amplitude Uₛₑₙₛ, where the block is controlled by the microcontroller. The block 4.3 serves for determining the real part Reₛₑₙₛ and imaginary part Imₛₑₙₛ of the measurement coil, and passes the signals on to the microcontroller 4.4.

The microcontroller 4.4 calculates the temperature of the measurement object that is independent of the inherent temperature T₂ of the sensor, using the signals from the blocks 4.1 and 4.3, and outputs it to the interface 5.

FIGS. 2a to 2d show various possibilities for being able to determine the inherent temperature of the sensor.

FIG. 2a shows that aside from supplying the measurement coil with alternating current and determining Re and Im of the coil from that, superimposition with direct current I_{DC} is also possible. The ohmic resistance of the coil can be determined from the voltage drop over the coil, which is brought about by the direct current, and from this a conclusion can be drawn concerning the temperature of the sensor.

FIG. 2b shows the use of a compensation coil L_{T2} as described under the point “differential coil arrangement.” The shielding that is shown in the drawing and the reference target are optional.

FIG. 2c represents a possibility for embedding a temperature measurement element in the form of a temperature-dependent resistor (PTC, NTC), a thermal element (PT100, PT1000, or the like), or an integrated circuit in the region of the measurement coil.

FIG. 2d represents the possibility of a coil wound in bifilar manner, where the representation is merely schematic. In the case of a wound embodiment of the sensor, this winding can be smaller or greater in diameter than the measurement winding, or also can be affixed on the inside and on the outside. In a preferred embodiment of the sensor element in a ceramic substrate, this winding can also be spatially distributed around the measurement coil, in order to be able to detect possible temperature gradients.

FIGS. 3a and 3b show a possible exemplary embodiment. Measurement of the temperature of a brake disk or of the brake lining of a brake is shown. The rotating brake disk 6 is shown only in part, as is the brake caliper 7 with the brake linings. To measure the temperature of the brake disk, various installation positions of the sensor are possible, indicated in FIG. 3a with the reference symbols 8.1 to 8.3.

8.1 refers to measurement of the temperature at the face side of the brake disk, where the position of the sensor in the region of the brake caliper is only an example.

8.2 shows measurement of the temperature of the brake disk on the friction surface of the disk, where attachment of the sensor element is provided on the brake lining, but also can take place on a separate holder. It becomes clear here that the distance independence is important here, because the distance between sensor and disk changes as a result of wear of the brake disk, and also due to impacts of the brake disk.

8.3 represents installation in the region of the axis of the brake disk, where the measurement also takes place against the narrow inside surface of the disk. Here, protected installation of the sensor is possible.

The installation position 8.4 of the sensor shown in FIG. 3b represents measurement of the temperature of the brake lining 7 or its back side. If the material of the lining is not suitable as a measurement object, a specially selected target can be affixed on the lining, with thermally good coupling. In order to achieve the fastest possible response, the thermal mass of this measurement object can be kept as low as possible. In this connection, a suitable coating of the lining would be possible. Here, wear of the lining cannot damage the sensor, because of the contact-free measurement method, whereas this is likely in the case of a temperature probe embedded into the lining.

In FIG. 4, measurement of the temperature of non-ferromagnetic strips (e.g. aluminum) in a rolling mill, during the rolling process, is shown as a further example of use of the sensor according to the invention. Because the degree of contamination is very high in the region of the rollers, optical methods are subject to break-down. Likewise, cooling of the optical sensors is necessary because of the high ambient temperatures in the region of the metal sheet 9. Because of the robust structure, but above all because of the preferred embodiment in a ceramic substrate, the proposed sensor 8 can detect the temperature of the sheet metal 9, without being influenced by the contaminated environment and the high temperature. By means of the distance-independent measurement, vibration of the sheet metal 10 during the rolling process also cannot influence the temperature measurement.

With regard to further advantageous embodiments of the sensor and system according to the invention, and of the method according to the invention, reference is made to the general part of the description and to the attached claims, in order to avoid repetition.

Finally, it should be explicitly pointed out that the exemplary embodiments described above merely serve to explain the claimed teaching, but do not restrict this teaching to the exemplary embodiments.

1.-16. (canceled)

17. An eddy current sensor that works in contact-free manner, for temperature measurement on an electrically conductive measurement object or component, the eddy current sensor being configured such that:
the measurement is independent of the distance between the sensor and the measurement object/component, wherein the inherent temperature of the sensor is determined, preferably at the location of the measurement coil, and wherein the influence of the inherent temperature of the sensor or of a temperature gradient at the sensor on the result of the temperature measurement at the measurement object or component is compensated.

18. The eddy current sensor according to claim 17, wherein DC superimposition is used for determining the direct current resistance of the measurement coil, wherein a direct current is superimposed on the alternating current of the measurement coil, and a conclusion concerning the ohmic resistance of the measurement coil is drawn from the change in the steady component, and wherein the change in the resistance is a measure of the temperature change of the measurement coil.

19. The eddy current sensor according to claim 17, wherein a temperature probe serves for indirect temperature measurement in the sensor, which probe is preferably integrated into the sensor or embedded in the sensor, thereby making it possible to detect the temperature in the immediate vicinity of the measurement coil.

20. The eddy current sensor according to claim 17, wherein a temperature measurement winding is used for compensation of a temperature gradient beyond the measurement coil, wherein the temperature measurement winding is disposed locally distributed around the measurement coil.

21. The eddy current sensor according to claim 17, wherein a bifilar arrangement of the temperature measurement winding is used, particularly in the case of construction of the sensor in a ceramic substrate.

22. The eddy current sensor according to claim 17, wherein a toroid winding or coil is disposed around the measurement coil, operated with alternating voltage, wherein the field of the toroid coil forms only in the interior of the coil.

23. The eddy current sensor according to claim 22, wherein a differential arrangement of the measurement coil is used, for example in the form of a half bridge supplied with alternating current, wherein the toroid coil allows direct compensation of the sensor temperature.

24. The eddy current sensor according to claim 17, wherein a differential coil arrangement of the measurement coil is used with a further compensation coil, similar in construction to the measurement coil, wherein the compensation coil is damped in defined manner by a reference measurement object, and remains uninfluenced by the temperature-affected measurement object.

25. The eddy current sensor according to claim 24, wherein there is a fixed distance of the reference measurement object from the measurement coil, wherein temperature compensation of the sensor is possible, for example, in a half bridge circuit.

26. The eddy current sensor according to claim 17, wherein a coil is disposed in a housing, on the face side relative to the measurement object, the coil is connected with the electronics of the sensor by way of a sensor line, the electronics supply alternating current at a constant frequency to the coil, the impedance of the coil is evaluated in the electronics, in that the real part and the imaginary part of the impedance are evaluated, preferably using a microcontroller or signal processor, and wherein the distance and/or the temperature is/are determined from the two measurement values.

27. The eddy sensor according to claim 17, wherein the measurement coil is embedded and, if necessary, the additional coil that serves for temperature compensation is embedded, in ceramic, preferably in multi-layer ceramic substrates.

28. The eddy current sensor according to claim 27, wherein the measurement coil and, if necessary, the additional coil is sintered in ceramic.

29. The eddy current sensor according to claim 17, wherein an embodiment in LTCC (low temperature co-fired ceramics) or in HTCC (high temperature co-fired ceramics) is used.

30. The eddy current sensor according to claim 17, wherein a sensor element is a part or component of the housing.

31. A system comprising:
an eddy current sensor that works in contact-free manner and an electrically conductive measurement object that is assigned to any desired component, for temperature measurement on the component, wherein the measurement is independent of the distance between the sensor and the measurement object or component, wherein the inherent temperature of the sensor is determined, preferably at the location of the measurement coil, wherein the influence of the inherent temperature of the sensor or of a temperature gradient at the sensor on the result of the temperature measurement at the measurement object or component is compensated, and
wherein the inherent temperature of the sensor is measured, and its influence on the result of the temperature measurement is compensated.

32. A method for temperature measurement on a measurement object or component, by means of an eddy current sensor that works in contact-free manner, wherein the measurement is conducted independent of the distance between the sensor and the measurement object/component, wherein the inherent temperature of the sensor is determined, preferably at the location of the measurement coil, wherein the influence of the inherent temperature of the sensor or of a temperature gradient at the sensor on the result of the temperature measurement at the measurement object or component is compensated, and
wherein the inherent temperature of the sensor is measured, and its influence on the result of the temperature measurement is compensated.
